(19) United States
(12) Patent Application Publication
(10) Pub. No.: US 2013/0067050 A1
(43) Pub. Date: Mar. 14, 2013

(54) PLAYBACK MANAGER

(71) Applicants: Kishore Kotteri, Bothell, WA (US); Frank Yerrace, Woodinville, WA (US); Ken Cooper, Renton, WA (US); Johnny Bregar, Bainbridge Island, WA (US); Nicholas J. Benson, Seattle, WA (US); Ryan Beberwyck, Redmond, WA (US); Rian Chung, Redmond, WA (US)

(72) Inventors: Kishore Kotteri, Bothell, WA (US); Frank Yerrace, Woodinville, WA (US); Ken Cooper, Renton, WA (US); Johnny Bregar, Bainbridge Island, WA (US); Nicholas J. Benson, Seattle, WA (US); Ryan Beberwyck, Redmond, WA (US); Rian Chung, Redmond, WA (US)

(73) Assignee: Microsoft Corporation, Redmond, WA (US)

(21) Appl. No.: 13/229,725

(22) Filed: Sep. 11, 2011

(51) Int. Cl. G06F 15/173

(52) U.S. Cl. 709/223

(57) ABSTRACT

In one embodiment, a computer audio system may use a playback manager to manage the audio streams of audio applications. A playback manager 202 may receive an audio stream category declaration 300 from an audio application 204. The playback manager 202 may determine a media focus status for an audio stream of the audio application 204 based in part on the audio stream category declaration 300.

### BACKGROUND

Many current applications executed on a modern computer feature an audio component. A media player application may play a digital song file. A video game may have music and incidental game sounds. A video chat program may render a voice transmission from a remote party.

Most modern computers may have a set of limited audio resources to execute those audio components. Each audio stream of the application may compete for use of the audio resources. The computer may merge the audio streams from each active application and play the combined audio back to the user.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a computer audio system that may use a playback manager to manage the audio streams of audio applications. A playback manager may receive an audio stream category declaration from an audio application. The playback manager may determine a media focus status for an audio stream of the audio application based in part on the audio stream category declaration.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, one embodiment of an audio resource management layout.

FIG. 3 illustrates, in a block diagram, one embodiment of an audio stream category declaration.

FIG. 4 illustrates, in a flowchart, one embodiment of a method of managing audio streams with a playback manager.

FIG. 5 illustrates, in a flowchart, one embodiment of a method of determining a media focus status of an audio stream.

FIG. 6. Illustrates, in a flowchart, one embodiment of a method of declaring an audio stream category.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a computer audio system for a computing device.

If a user may interact with one application via a visual or graphical interface at a time, a computer audio system may treat an application that plays audio, or an audio application, differently from applications that do not play audio. An audio application is any application that has an audio output, whether as the primary purpose of the application or as an incidental result of the application.

A foreground application is an application that executes while visually displaying a graphical user interface to the user. A background application is an application that executes without visually displaying a graphical user interface to the user. A background application may be moved to the foreground by producing a graphical user interface for the application to the user, while the foreground application may be moved to the background by minimizing or removing the graphical user interface for the application.

Audio applications may continue to provide audio streams while being executed in the background. The computer audio system may use a playback manager to determine which audio applications may still be heard by the user while operating in the background. The playback manager may also route any media control commands to the proper audio application and manage utilization of audio resources. The media control commands may originate from a physical input, an operating system user interface, or other sources outside the application.

An audio application may declare the category of the audio being played back to a playback manager and register for media focus status notifications and transport control notifications. The playback manager may reside alongside the audio server and monitor the audio applications. The audio server is a set of audio services provided by the operating system. The playback manager may use the self-declared audio stream category to determine a media focus status of the audio application and make routing decisions for transport control notifications. The media focus status describes if an audio application or an audio stream of the audio application has media focus and is played to the user, or does not have media focus and is not played to the user. The playback manager may arbitrate the use of audio resources between audio applications on the system.

The playback manager may assign an audio stream category on an application basis or an individual audio stream basis. By declaring an application audio stream category for the audio application, the audio application may apply a relevant audio stream category to each audio stream from that audio application. The playback manager may assign an application audio stream category to an audio application based on the audio stream categories of the audio streams of the audio application.

The playback manager may assign a primary audio stream category or a secondary audio stream category to an audio stream based on the audio stream category declaration. A primary audio stream category indicates an audio stream to be played regardless of the shell state of the audio application. The shell state describes whether the audio application is in the foreground or in the background. A secondary audio stream category indicates an audio stream to be played when the audio application is in a foreground shell state. A first audio application with a primary audio stream category in the background shell state may have its audio stream merged with a second audio application in the foreground shell state. Alternatively, if the second audio application has a secondary audio stream category, the first audio application may interrupt any audio stream from the second audio application.

Additionally, an audio application may have a priority audio stream category, allowing that audio application to interrupt the audio streams of any other audio applications. The priority audio stream category may be used for an application having a communication audio stream category, such as a voice over internet protocol (VOIP) application. Conversely, an audio application may have a null audio stream category, preventing any of the audio streams of that audio application being played. The null audio stream category may be applied to programs with nonessential audio, unidentified audio, or even malware.

The playback manager may use the application audio stream category of an audio application to determine the media focus status of that audio application. An audio application having media focus has audio streams that may be heard by the user. An audio application having lost media focus has no audio streams that are heard by the user. The audio application may or may not receive an error notification indicating whether the audio streams are being heard by the user. An audio application without media focus may have any audio streams from that audio application muted in a manner transparent to the application.

The playback manager implements media focus status and other audio policies for the computer audio system. The playback manager may have a communication channel with the operating shell to get information about the shell state of each application, such as visibility to the user. Using the shell state and the audio stream category, the playback manager may play audio streams from an audio application having a primary audio stream category even when that audio application is in a background shell state. The playback manager may attenuate or fully mute the other audio streams when a communications stream is activated. The playback manager may also coordinate with other operating system components to arbitrate audio resources among multiple audio applications based on a shell state and audio categories. An audio application with a secondary audio stream category may lose media focus when moved to the background.

The playback manager may notify an audio application when media focus is granted or revoked. Upon the loss of media focus, the audio application may choose to perform optimizations in order to save processing and network resources and improve the user experience of the application. The audio application may pause the current activity after a change in media focus status, such as pausing media playback or pausing a game. The audio application may receive notifications by registering callbacks with the playback manager. An audio application may choose to ignore the media focus status notifications sent by the playback manager.

The playback manager may intelligently route transport control commands that originate from a transport control input, such as outside applications or hardware. For example, the playback manager may route signals from a remote control, a keyboard, or a soft button provided by the operating system user interface to the audio application, even when in a background shell state. The playback manager may route commands to an audio application that has been granted media focus. The operating system user interface may determine whether to display soft transport control buttons by querying the playback manager for active audio applications having media focus.

Audio applications may consume limited hardware or software resources. The playback manager may improve the efficiency of those resources by favoring allocation of limited audio resources to the audio application with media focus. The audio application, upon notification of a revoked media focus, may optimize operations to consume fewer resources.

Thus, in one embodiment, a computer audio system may use a playback manager to manage the audio streams of audio applications. A playback manager receives audio with a certain specified or computed audio stream category from an audio application. The playback manager may determine a media focus status for an audio stream of the audio application based in part on the audio stream category.

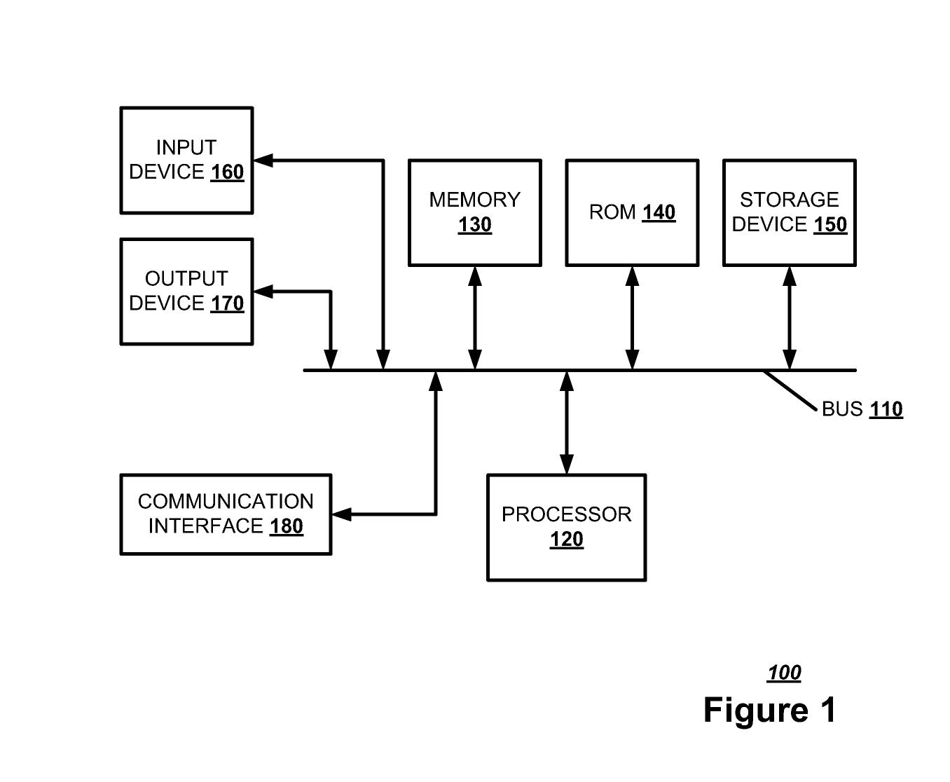

FIG. 1 illustrates a block diagram of an exemplary computing device 100 which may act as computer audio system. The computing device 100 may combine one or more of hardware, software, firmware, and system-on-a-chip technology to implement computer audio management. The computing device 100 may include a bus 110, a processor 120, a memory 130, a read only memory (ROM) 140, a storage device 150, an input device 160, an output device 170, and a communication interface 180. The bus 110 may permit communication among the components of the computing device 100.

The processor 120 may include at least one conventional processor or microprocessor that interprets and executes a set of instructions. The memory 130 may be a random access memory (RAM) or another type of dynamic storage device that stores information and instructions for execution by the processor 120. The memory 130 may also store temporary variables or other intermediate information used during execution of instructions by the processor 120. The ROM 140 may include a conventional ROM device or another type of static storage device that stores static information and instructions for the processor 120. The storage device 150 may include any type of tangible machine-readable medium, such as, for example, magnetic or optical recording media and its corresponding drive. The storage device 150 may store a set of instructions detailing a method that when executed by one or more processors cause the one or more processors to perform the method. The storage device 150 may also be a database or a database interface for storing an audio stream category for an audio application.

The input device 160 may include one or more conventional mechanisms that permit a user to input information to the computing device 100, such as a touch screen, a keyboard, a mouse, a voice recognition device, a microphone, a headset, etc. The output device 170 may include one or more conventional mechanisms that output information to the user, including a display, a printer, one or more speakers, a headset, or a medium, such as a memory, or a magnetic or optical disk and a corresponding disk drive. Additionally, the output device 170 may be one or more audio resources to produce an audio output for the computer, such as speakers or a headphone jack. The communication interface 180 may include any transceiver-like mechanism that enables processing device 100 to communicate with other devices or networks. The communication interface 180 may include a network interface or a mobile transceiver interface. The communication interface 180 may be a wireless, wired, or optical interface.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the storage device 150, or from a separate device via the communication interface 180.

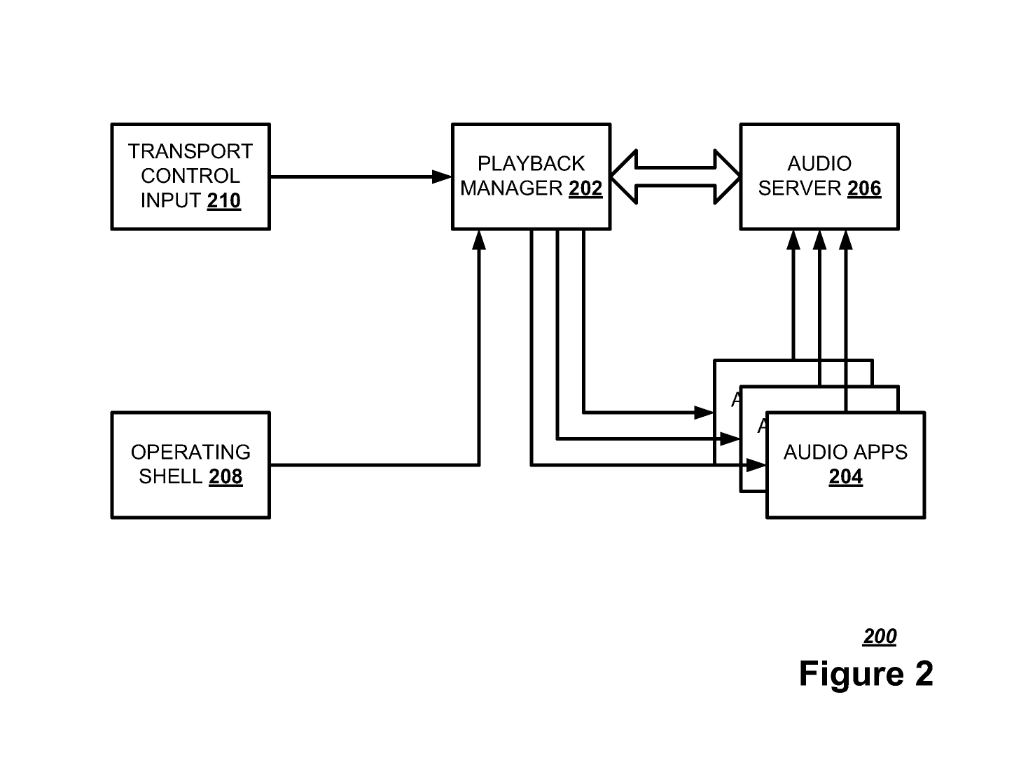

The computer device 100 may implement an audio resource management layout to control the use of the computer audio resources by an application. FIG. 2 illustrates, in a block diagram, one embodiment of an audio resource management layout 200. The audio resource management layout may use a playback manager 202 to control the transmission of audio streams from one or more audio applications 204 to an audio server 206. The audio server 206 is the system of audio resources used by the computer device 100 to produce an audio output. The audio server 206 may include application programming interfaces, support routines, and hardware specific software drivers. The playback manager 202 may notify an audio application 204 of any changes to the media focus status of the audio application 204. While the audio application 204 has media focus, the audio application 204 may send an audio stream to the audio server 206. The audio application may use an application programming interface (API), such as a Windows® audio session application programming interface (WASAPI), to send the audio stream to the audio server 206. The playback manager 202 may send commands to the audio server 206 that influence how the streams of the audio application are handled.

The operating shell 208 may send a notification to the playback manager 202 of any changes to the shell state of any of the audio applications 204. An audio application 204 may change from a foreground shell state, with the audio application active and displayed to a user, to a background shell state, with the audio application active but not fully displayed to the user. The operating shell 208 may send a shell change notification to the playback manager 202 if an audio application 204 changes shell state. The playback manager 202 may use the shell state, in conjunction with an audio stream category of an audio application, to determine the media focus status for an audio application 204 or an audio stream of the audio application 204. The audio stream category may refer to an application audio stream category of an audio application 204 or an audio stream category of an audio stream of the audio application 204. If the audio application 204 has a primary audio stream category, the audio application 204 may be granted media focus regardless of the shell state. If the audio application 204 has a secondary audio stream category, the audio application 204 may be granted media focus while having a foreground shell state but may lose media focus while having a background shell state.

A transport control input 210 may send transport control commands and other media control commands to the playback manager 202. The playback manager 202 may send those transport control commands and other media control commands to those audio applications 204 having a media focus. Additionally, the transport control input 210 may be used by the user to directly change the audio stream category or the media focus status of an audio application 204 by sending a user override.

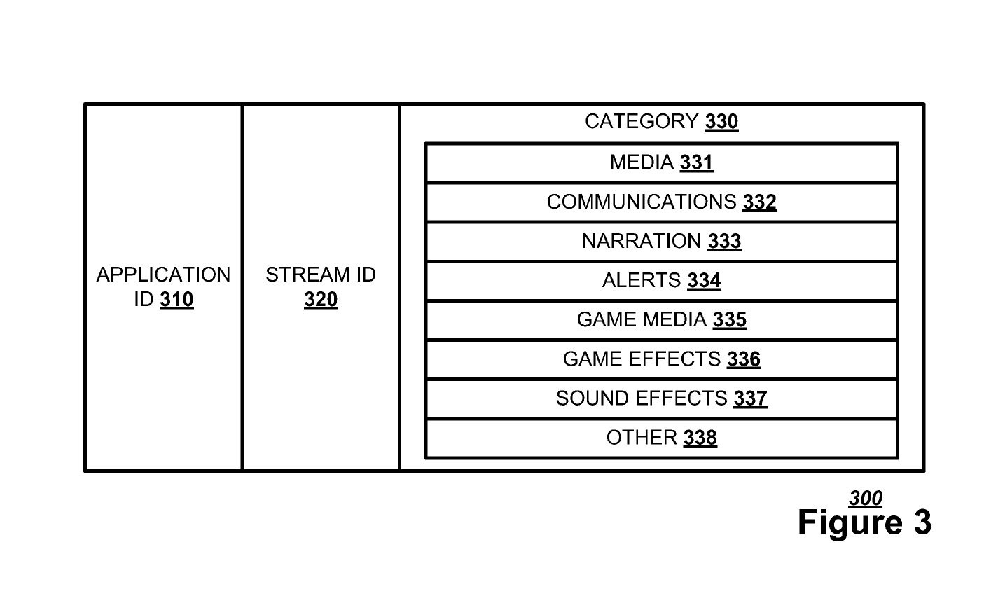

An audio application 204 may declare the audio stream category of the audio streams that the audio application 204 is playing. The playback manager 202 may use the audio stream category to determine whether the audio application 204 has media focus and to prioritize audio streams among audio applications 204. FIG. 3 illustrates, in a block diagram, one embodiment of an audio stream category declaration 300 that the audio application 204 may send to the playback manager to identify the audio stream category for that audio application 204. The audio stream category declaration 300 may have an application identifier (ID) 310 to identify the audio application 204 sending the audio stream category declaration 300. The audio stream category declaration 300 may have a stream identifier 320 if the audio stream category is applied on a stream-by-stream basis, as opposed to an application-by-application basis. The audio stream category declaration 300 may have a category field 330, identifying the type of audio stream being provided by the audio application 204.

The category field 330 may identify an audio application 204 or an audio stream as media 331, communications 332, narration 333, alerts 334, game media 335, game effects 336, sound effects 337, or other 338. Media 331 may describe any multimedia content, such as music players or video players. Communications 332 may describe voice over internet protocol applications or chat applications. Narration 333 may describe narration software, book readers, or other text-to-audio readers. Alerts 334 may describe ring tones, low battery alerts, or other notification software or components. Game media 335 may describe background game audio and other sounds associated with games. Game effects 336 may specifically describe the sound effects in games. Sound effects 337 may describe sound effects used in non-game applications. Other 338 may be used as a default category to describe any unclassified audio streams. Some categories 330, such as media 331, communications 332, or narration 333, may be considered primary media categories, while the other categories 330 may considered secondary media categories.

For a computer audio system that applies an audio stream category on an application-by-application basis, the category field 330 may describe the general type of the audio streams being provided, but not every audio stream. For example, an audio application 204 identified as game media 335 may provide one or more communications 332 audio streams in addition to several game media 335 streams.

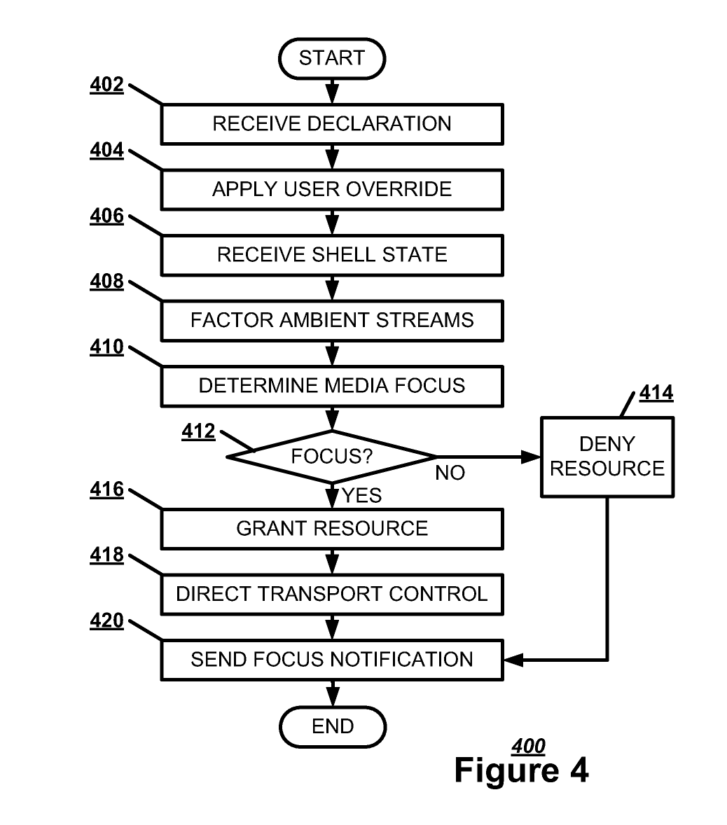

FIG. 4 illustrates, in a flowchart, one embodiment of a method 400 of managing audio streams at a playback manager 202. The playback manager 202 may receive an audio stream category declaration 300 from an audio application 204 (Block 402). The playback manager 202 may apply any user override to the audio stream category declaration 300 (Block 404). The user override is an input from the user indicating disagreement with the audio stream category declaration from the audio application 204. The user may designate an alternate audio stream category for the audio application or the audio stream. The playback manager 202 may receive a shell state for the audio application 204 from an operating shell 208 (Block 406). The playback manager 202 may factor any ambient audio stream categories for any ambient audio streams into any determination of media focus status (Block 408). An ambient audio stream is any audio stream being fed into the audio server 206. An ambient audio stream category is an audio stream category for that ambient audio stream. The playback manager 202 may determine a media focus status based in part on the audio stream category declaration 300 and in part on the shell state (Block 410). The media focus status may be for the audio application or for an audio stream of the audio application 204.

If the audio stream does not have media focus (Block 412), the playback manager 202 may deny an audio resource for the audio stream (Block 414). If the audio stream has media focus (Block 412), the playback manager 202 may grant audio resources to the audio stream (Block 416). The playback manager 202 may direct a transport control notification to the audio application 204 with the audio stream having media focus (Block 418). The playback manager 202 may send a media focus status notification to the audio application 204 (Block 420).

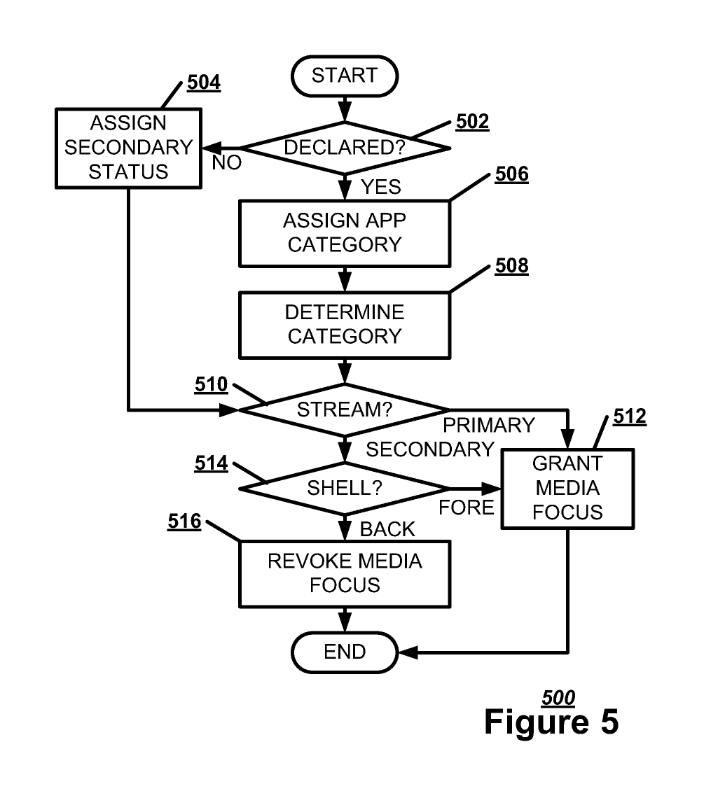

FIG. 5 illustrates, in a flowchart, one embodiment of a method 500 of determining a media focus status of an audio stream. If an audio application 204 is an undeclared audio application that fails to declare an audio stream category (Block 502), the playback manager 202 may assign a secondary audio stream category to the undeclared audio application (Block 504). In this instance, an undeclared audio application is any audio application that fails to declare an audio stream category. The playback manager 202 may assign an application audio stream category to the audio application 204 based on the audio stream category declaration (Block 506). The playback manager 202 may determine that the audio stream is at least one of a primary audio stream category and a secondary audio stream category based on the audio stream category declaration (Block 508). If the audio stream belongs to a primary audio stream category (Block 510), the playback manager 202 may grant media focus to the audio stream (Block 512). If the audio stream belongs to a secondary audio stream category (Block 510) and the audio application 204 is in a foreground shell state (Block 514), the playback manager 202 may grant media focus to the audio stream (Block 512). If the audio stream has a secondary audio stream category (Block 510) and the audio application 204 is in a background shell state (Block 514), the playback manager 202 may revoke media focus to the audio stream (Block 516).

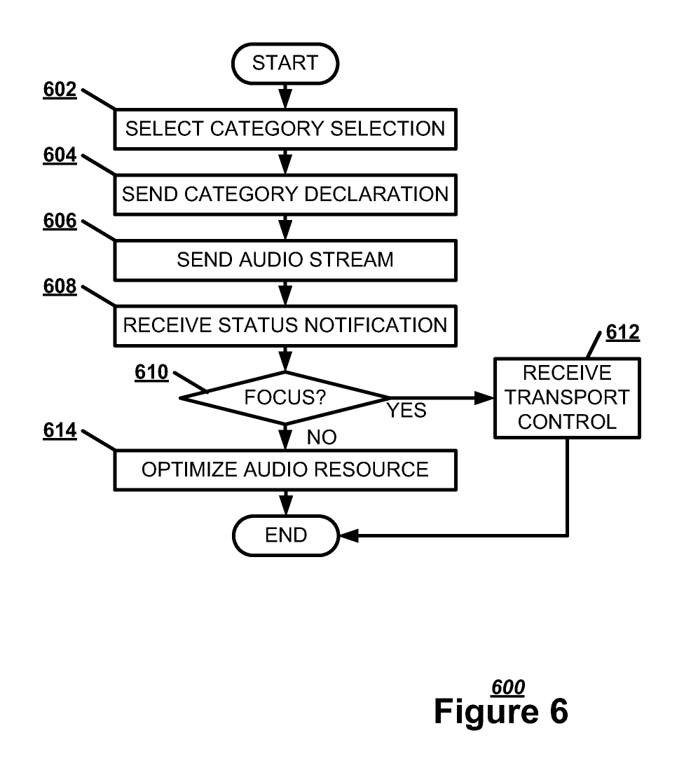

FIG. 6. Illustrates, in a flowchart, one embodiment of a method 600 of establishing an audio stream category at an audio application. The audio application 204 may select an audio stream category (Block 602). The audio application 204 may select at least one of media, communications, narration, alerts, game media, game effects, sound effects and other as the audio stream category selection. The audio application 204 may send an audio stream category declaration 300 to a playback manager 202 for the playback manager 202 to use in determining a media focus status for an audio stream (Block 604). The audio application 204 may send the audio stream to the audio server 206 to be processed based on the media focus status (Block 606). The audio application 204 may receive a media focus status notification from the playback manager 202 (Block 608). If the audio application 204 is granted media focus (Block 610), the audio application 204 may receive a transport control notification while having media focus (Block 612). If the audio application 204 receives notice of a media focus revocation (Block 610), the audio application 204 may optimize use of audio resources (Block 614).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
receiving an audio stream category declaration from an audio application; and
determining with a playback manager a media focus status for an audio stream of the audio application based in part on the audio stream category declaration.

2. The method of claim 1, further comprising:
factoring an ambient audio stream category for an ambient audio stream into determining the media focus status for the audio stream.

3. The method of claim 1, further comprising:
assigning an application audio stream category to the audio application based on the audio stream category declaration.

4. The method of claim 1, further comprising:
granting an audio resource to the audio stream having media focus.

5. The method of claim 1, further comprising:
denying an audio resource for the audio stream without media focus.

6. The method of claim 1, further comprising:
receiving in the playback manager a shell state for the audio application from an operating shell.

7. The method of claim 6, further comprising:
determining with the playback manager the media focus status for the audio stream based in part on the shell state.

8. The method of claim 1, further comprising:
sending a media focus status notification to the audio application.

9. The method of claim 1, further comprising:
directing a transport control notification to the audio application with the audio stream having media focus.

10. The method of claim 1, further comprising:
applying a user override to the audio stream category declaration.

11. The method of claim 1, further comprising:
determining that the audio stream is at least one of a primary audio stream category and a secondary audio stream category based on the audio stream category declaration.

12. The method of claim 1, further comprising:
assigning a secondary audio stream category to an undeclared audio application that fails to declare an audio stream category.

13. A tangible machine-readable medium having a set of instructions detailing a method stored thereon that when executed by one or more processors cause the one or more processors to perform the method, the method comprising:
sending from an audio application an audio stream category declaration to a playback manager for the playback manager to use in determining a media focus status for an audio stream; and
sending the audio stream to an audio server to be processed based on the media focus status.

14. The tangible machine-readable medium of claim 13, wherein the method further comprises:
selecting at least one of media, communications, narration, alerts, game media, game effects, and sound effects as the audio stream category selection.

15. The tangible machine-readable medium of claim 13, wherein the method further comprises:
receiving a media focus status notification from the playback manager.

16. The tangible machine-readable medium of claim 13, wherein the method further comprises:
optimizing use of an audio resource upon notice of a media focus revocation.

17. The tangible machine-readable medium of claim 13, wherein the method further comprises:
receiving a transport control notification while having media focus.

18. A computer audio system, comprising:
a processor that executes a playback manager to receive an audio stream category selection from an audio application and determine a media focus status for an audio stream of the audio application based in part on the audio stream category selection; and
an audio resource that receives the audio stream having media focus.

19. The computer audio system of claim 18, further comprising:
a transport control input to control the audio application with the audio stream having media focus.

20. The computer audio system of claim 18, wherein the playback manager determines the media focus status base in part on a shell state for the audio application.
